(19) United States
(12) Patent Application Publication
(10) Pub. No.: US 2009/0004441 A1
(43) Pub. Date: Jan. 1, 2009

(54) Process For Treating Substrates

(75) Inventors: Karl Haberle, Speyer (DE); Karl Siemensmeyer, Frankenthal (DE); Ralf Norenberg, Ludwigshafen (DE); Oihana Elizalde, Mannheim (DE); Maria Teresa Fonseca, Burstadt (DE); Jurgen Reichert, Limburgerhof (DE); Rolf Strobel, Hechingen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/161,966

(22) PCT Filed: Jan. 24, 2007
(86) PCT No.: PCT/EP2007/050682

§ 371 Date: Jul. 24, 2008

(30) Foreign Application Priority Data
Feb. 3, 2006 (EP) 06101262.1
Mar. 24, 2006 (EP) 06111689.3
Oct. 27, 2006 (DE) 10 2006 051 415.7

(51) Int. Cl. B32B 3/10; C08G 73/10; D06P 1/00; B05D 3/02; C08L 33/10

(52) U.S. Cl. 428/195.1; 525/185; 524/514; 427/385.5; 8/636

(57) ABSTRACT

A process for treating a substrate comprises utilizing at least one aqueous formulation comprising
(A) at least one binder obtainable by copolymerization of ethylene and (meth)acrylic acid and optionally one or more further comonomers,
(B) at least one reaction product of at least one carbodiimide (C) with at least one diol, triol or polyol (D), or
(C) at least one carbodiimide and
   optionally at least one diol, triol or polyol.

The present invention relates to a process for treating a substrate, which comprises utilizing at least one aqueous formulation comprising
(A) at least one binder obtainable by copolymerization of ethylene and (meth)acrylic acid and optionally one or more further comonomers,
(B) at least one reaction product of at least one carbodiimide (C) with at least one diol, trio or polyol (D), or
(C) at least one carbodiimide and
(D) optionally at least one diol, triol or polyol.

The present invention further relates to aqueous formulations useful for carrying out the process of the present invention and to a process for producing the aqueous formulations of the present invention.

The present invention further relates to flexible substrates treated by the process of the present invention.

Many substrates such as textile and leather for example need a treatment to acquire their desired performance characteristics. Suitable treatments may be for example printing, coating or dyeing. The expectations of a good treatment are high. The substrates shall have high service fastnesses, for example rub fastnesses, wash fastnesses and wet-rub fastnesses. The treatment shall do nothing to impair the performance of the active and special-effect components, in particular colorant components. Nor shall the treatment have any adverse health effects. For example, it shall not cause any health-endangering emissions, such as formaldehyde for example. Finally, the treatment shall be simple to apply.

Common treating agents are still in need of improvement with regard to the properties mentioned above. True, formaldehyde-free treating agents are known in principle, but fastnesses such as rub fastness, wash fastness and wet-rub fastness are generally not good. Similarly, the gray scale standard is still in need of improvement in many cases.

Against this background, we have found the process defined at the beginning.

The process defined at the beginning proceeds from at least one substrate, preferably from flexible substrate such as for example leather, leather imitations or polymeric films. Textile substrates are particularly preferred substrates. Textile substrates, or textile, for the purposes of the present invention are textile fibers, textile intermediate and end products and finished textile articles manufactured therefrom which, as well as textiles for the apparel industry, also comprise for example carpets and other home textiles and also textile constructions for industrial purposes. These may also include unshaped constructions, linear constructions such as twine, filaments, yarns, lines, strings, braids, cordage, threads and also three-dimensional constructions such as for example felts, wovens, formed-loop knits, nonwovens and waddings. Textiles can be of natural origin, for example cotton, wool or flax, or synthetic, for example polyamide, polyester, modified polyester, polyester blend fabric, polyamide blend fabric, polyacrylonitrile, triacetate, acetate, polycarbonate, polyolefins such as for example polyethylene and polypropylene, polyvinyl chloride, also polyester microfibers and glass fiber fabric. Very particular preference is given to polyester, cotton and polyolefins such as for example polyethylene and polypropylene and also to selected blend fabrics selected from cotton-polyester blend fabric, polyolefin-polyester blend fabric and polyolefin-cotton blend fabric.

Textile substrates composed of polyolefin such as polyethylene or polypropylene are very particularly preferred substrates. Polyolefins for the purposes of the present invention are preferably polyethylene and polypropylene, polyethylene comprising ethylene homopolymers and ethylene copolymers and polypropylene comprising propylene homopolymers and propylene copolymers. Preferred ethylene copolymers and propylene copolymers are copolymers of respectively ethylene and propylene with one or more ethylenically unsaturated compound, in particular with one or more olefins such as for example with propylene or ethylene or one or more α-olefins, for example 1-butene, 1-pentene, 1-hexene, 1-octene, 1-decene and 1-dodecene. Ethylene copolymers are particularly preferably copolymers of ethylene with up to 30% by weight of propylene, 1-butene, 1-hexene or 1-decene, and propylene copolymers are particularly preferably copolymers of propylene with up to 30% by weight of ethylene, 1-butene, 1-hexene or 1-decene.

Polyolefins for the purposes of the present invention may for example have an average molecular weight M_{w} in the range from 50 000 to 1 000 000 g/mol and preferably in the range from 100 000 to 500 000 g/mol.

Polyolefin is obtainable by methods known per se, for example in the case of polyethylene and ethylene copolymers by free-radical (co)polymerization or with the aid of a catalyst, for example with the aid of a Phillips, Ziegler-Natta or metallocene catalyst, and in the case of polypropylene and propylene copolymers with the aid of a catalyst, in particular a Ziegler-Natta catalyst or a metallocene catalyst.

According to the present invention, substrate is treated with at least one aqueous formulation. This is done by applying one or more aqueous formulations to the substrate to be treated and if appropriate performing further operations, for example before or after the applying of one or more aqueous formulations. In another embodiment, substrate is drenched with aqueous formulation of the present invention.

Pigments (E) or actives (F) of aqueous formulation of the present invention can remain overwhelmingly or completely on the substrate as a result of the applying or drenching, but they can also penetrate into the substrate to a certain extent.

One preferred embodiment comprises treating by printing substrate with aqueous formulation, Printing may be performed in accordance with conventional processes such as screen printing processes for example.

Another embodiment of the present invention comprises treating by dyeing substrate with aqueous formulation. Dyeing may be performed in accordance with conventional processes such as padding and exhaust processes for example.

Another embodiment of the present invention comprises treating by coating substrate with aqueous formulation.

The process of the present invention is carried out by coating using at least one aqueous formulation comprising:
(A) at least one binder comprising ethylene, (meth)acrylic acid and optionally one or more further comonomers in interpolymerized form, also referred to herein for short as binder (A),
(B) at least one reaction product of at least one carbodiimide (C) with at least one diol, triol or polyol (D), or
(C) at least one carbodiimide, also referred to herein as carbodiimide (C),
(D) optionally at least one diol, triol or polyol, also referred to herein for short as diol (D), triol (D) or polyol (D).

One embodiment of the present invention comprises choosing binder (A) from copolymers comprising ethylene, (meth)acrylic acid and if appropriate one or more further comonomers in interpolymerized form, for example one or more C₁-C₁₀-alkyl esters of (meth)acrylic acid, particularly methyl acrylate. Examples of further suitable comonomers are vinyl esters of carboxylic acids, for example vinyl propionate and vinyl acetate, and isobutene.

One specific embodiment of the present invention comprises choosing binder (A) from copolymers comprising ethylene and (meth)acrylic acid in interpolymerized form and otherwise no further comonomers.

One preferred variant of the two embodiments last mentioned comprises choosing binder (A) from copolymers comprising in interpolymerized form:

65% to 90% by weight and preferably 75% to 85% by weight of ethylene,
35% to 10% by weight and preferably 15% to 25% of (meth)acrylic acid,
0% to 20% by weight and preferably 0.1% to 15% by weight of further comonomer
such as C₁-C₁₀-alkyl ester of (meth)acrylic acid,
all based on total binder (A).

In one preferred variant of the two embodiments last mentioned, binders (A) may have a melt flow rate (MFR) in the range from 1 to 50 g/10 min, preferably in the range from 5 to 20 g/10 min and more preferably in the range from 7 to 15 g/10 min, measured at 160° C. and under a load of 325 g in accordance with EN ISO 1133.

One preferred variant of the two specific embodiments last mentioned comprises synthesizing binder (A) by copolymerization of ethylene, (meth)acrylic acid and if appropriate one or more C₁-C₁₀-alkyl esters of (meth)acrylic acid by free-radically initiated copolymerization under high pressure conditions, for example in stirred high pressure autoclaves or in high pressure tubular reactors. Production in stirred high pressure autoclaves is preferred. Stirred high pressure autoclaves are known per se, a description is to be found in Ullmann's Encyclopedia of Industrial Chemistry, 5th edition, headwords: waxes, volume A 28, pages 146 ff., Verlag Chemie Weinheim, Basle, Cambridge, New York, Tokyo, 1996. Their length/diameter ratio ranges predominantly in intervals from 5:1 to 30:1 and preferably from 10:1 to 20:1. The similarly useful high pressure tubular reactors are likewise to be found in Ullmann's Encyclopedia of Industrial Chemistry, 5th edition, headwords: waxes, volume A 28, pages 146 ff., Verlag Chemie Weinheim, Basle, Cambridge, New York, Tokyo, 1996.

Suitable pressure conditions for the polymerization are 500 to 4000 bar and preferably 1500 to 2500 bar. Conditions of this kind are hereinafter also referred to as high pressure. The reaction temperatures range from 170 to 300° C. and preferably from 195 to 280° C.

The carboxyl groups of the interpolymerized (meth)acrylic acid in binder (A) may be free or completely or partially neutralized, for example with alkali, with ammonia or with amine. Particularly suitable amines are for example tertiary amines, for example (C₁-C₄-alkyl)₃N, in particular triethylamine, and alkanolamines such as for example ethanolamine, diethanolamine, triethanolamine, N-methylethanolamine, N,N-dimethylethanolamine and N-(n-butyl)ethanolamine.

Binder (A) is preferably generated in the form of spheric particles dispersed in water. The spheric particles may for example have an average diameter in the range from 10 nm to 10 μm and preferably in the range from 20 nm to 1 μm.

Aqueous formulation used in the process of the present invention may further comprise at least one reaction product (B) obtainable by reaction of at least one carbodiimide (C) with at least one diol, triol or polyol (D). Such reaction products are herein also referred to as reaction product (B) for short.

Carbodiimide (C) may for example have the formula I

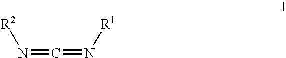

where R¹ and R² may be the same or different and selected from
C₁-C₂₀-alkyl, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl, n-dodecyl, iso-dodecyl, n-tetradecyl, n-hexadecyl, n-octadecyl, n-eicosyl; preferably C₁-C₁₀-alkyl, such as methyl, ethyl, n-propyl, iso-propyl, n-butyl, iso-butyl, sec-butyl, tert-butyl, n-pentyl, iso-pentyl, sec-pentyl, neo-pentyl, 1,2-dimethylpropyl, iso-amyl, n-hexyl, iso-hexyl, sec-hexyl, n-heptyl, n-octyl, 2-ethylhexyl, n-nonyl, n-decyl, more preferably C₁-C₄-alkyl such as methyl, ethyl, n-propyl, iso-propyl, n-butyl, iso-butyl, sec-butyl and tert-butyl;
C₃-C₂₀-cycloalkyl, monocyclic or bicyclic, unsubstituted or substituted with for example C₁-C₆-alkyl or with isocyanate, such as cyclopropyl, cyclobutyl, cyclopentyl, cyclohexyl, cycloheptyl, cyclooctyl, 2,5-dimethylcyclopentyl, 2,6-dimethyl-cyclohexyl, methyl-C₅-C₇-cycloalkyl, isocyanatocyclohexyl, methyl[isocyanato-C₅-C₇-cycloalkyl],
C₆-C₁₄-aryl, unsubstituted or singly or multiply substituted with for example C₁-C₆-alkyl or with isocyanate or with isocyanato-C₁-C₆-alkyl, in particular with C(CH₃)₂—NCO, such as for example —C₆H₃(CH₃)NCO, —C₆H₄—NCO, C₇-C₁₅-alkylaryl, in particular —C(CH₃)₂—C₆H₄—C(CH₃)₂—NCO, meta or para, methyl-C₅-C₇-cycloalkyl, unsubstituted or substituted with isocyanate or with isocyanato-C₁-C₆-alkyl, in particular with C(CH₃)₂—NCO,
isophoryl, cyclohexyl,
C₃-C₆-heteroaryl, for example imidazolyl.

Carbodiimide (C) preferably comprises polymeric carbodiimide. Polymeric carbodiimides herein are such compounds as bear from 2 to 50 and preferably up to 20-N═C═N groups per mole.

Polymeric carbodiimides are known per se and are preparable in a conventional manner, for example by condensation or polycondensation of diisocyanate in the presence of catalysts, for example trialkylphosphine oxide, acyclic or preferably cyclic, also as phospholine oxide, triarylphosphine oxide, alkali metal alkoxide, for example sodium methoxide, alkali metal carbonate, for example sodium carbonate or potassium carbonate, or tertiary amine, for example triethylamine. Particularly suitable catalysts are phospholane oxides and phospholine oxides, for example 1-phenyl-2-methyl-phospholine 2-oxide, 1-phenyl-2-methylphospholine 3-oxide, 1-methylphospholine 2-oxide and 1-methylphospholine 3-oxide, see for example U.S. Pat. No. 2,853,473. Carbon dioxide is detached in the course of the condensation or polycondensation to form the polymeric carbodiimide.

Examples of polymeric carbodiimides are obtainable by condensation or polycondensation of at least one aromatic diisocyanate, for example 2,4-tolylene diisocyanate, 4,4′-diphenylmethane diisocyanate or 1,7-naphthylene diisocyanate, or at least one aliphatic or cycloaliphatic carbodiimide such as for example isophorone diisocyanate, trimethylene diisocyanate, tetramethylene diisocyanate, hexamethylene diisocyanate, dodecamethylene diisocyanate, cyclohexane 1,4-diisocyanate, 2,4-hexahydrotolylene diisocyanate, 2,6-hexahydrotolylene diisocyanate and 4,4′-dicyclohexylmethane diisocyanate.

Preferred polymeric carbodiimides are copolycarbodiimides obtainable by condensation or polycondensation of at least one aromatic diisocyanate, for example 2,4-tolylene diisocyanate, 4,4′-diphenylmethane diisocyanate or 1,7-naphthylene diisocyanate, with at least one aliphatic or cycloaliphatic carbodiimide such as for example isophorone diisocyanate, trimethylene diisocyanate, tetramethylene diisocyanate, hexamethylene diisocyanate, dodecamethylene diisocyanate, cyclohexane 1,4-diisocyanate, 2,4-hexahydrotolylene diisocyanate, 2,6-hexahydro-tolylene diisocyanate and 4,4′-dicyclohexylmethane diisocyanate.

It is very particularly preferred for carbodiimide (C) to comprise a polymeric carbodiimide obtainable by polycondensation of m-TMXDI or p-TMXDI

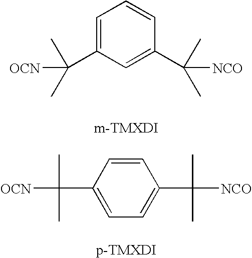

or mixtures of m-TMXDI and p-TMXDI having 2 to 20, preferably up to 15 and more preferably up to 10-N═C═N groups per mole.

Reaction partner of carbodiimide (C) is at least one diol (D), triol (D) or polyol (D). Examples of suitable diols (D) are ethylene glycol, diethylene glycol, triethylene glycol, tetraethylene glycol, 1,3-propanediol, 1,4-butanediol, propylene glycol, dipropylene glycol, tripropylene glycol, tetrapropylene glycol, butylene glycol, 1,6-hexanediol, 1,5-pentanediol, polyethylene glycol having an average molecular weight Mₙ in the range from 200 to 5000 g/mol, polypropylene glycol having an average molecular weight Mₙ in the range from 200 to 5000 g/mol, polytetrahydrofuran having a molecular weight Mₙ in the range from 200 to 5000 g/mol, ethylene oxide-propylene oxide copolymers, particularly block copolymers of ethylene oxide and propylene oxide.

Examples of preferred diols (D) further include aromatic diols such as for example resorcinol, hydroquinone, 4,4′-biphenyldiol, hydroquinone di-(para-hydroxybenzoate), bisphenol A and also alkoxylation products, particularly ethoxylation products and propoxylation products of the aforementioned aromatic diols, such as for example compounds of the general formula II

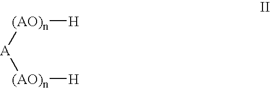

where
A is a bivalent organic radical having a up to 40 carbon atoms, preferably 2 to carbon atoms, preferably an organic diol, particularly an organic radical having at least one and preferably at least two phenyl rings, which may each be substituted, for example para-O—C₆H₄—O—, para,para′-O—C₆H₄—C₆H₄—O—, para,para′-O—C₆H₄—C(CH₃)₂—C₆H₄—O—,

AO is selected from C₂-C₄-alkylene oxide, for example butylene oxide, particularly ethylene oxide CH₂CH₂O (“EO”) and propylene oxide CH₂C(CH₃)O (“PO”)
n in each occurrence is different or preferably the same and selected from numbers in the range from zero to 50, preferably in the range from 2 to 20 and more preferably in the range from 3 to 15.

Preference is given to compounds of the formula III

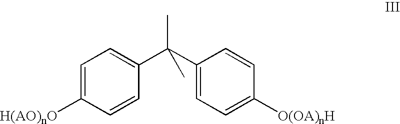

Examples of very particularly preferred diols (D) are

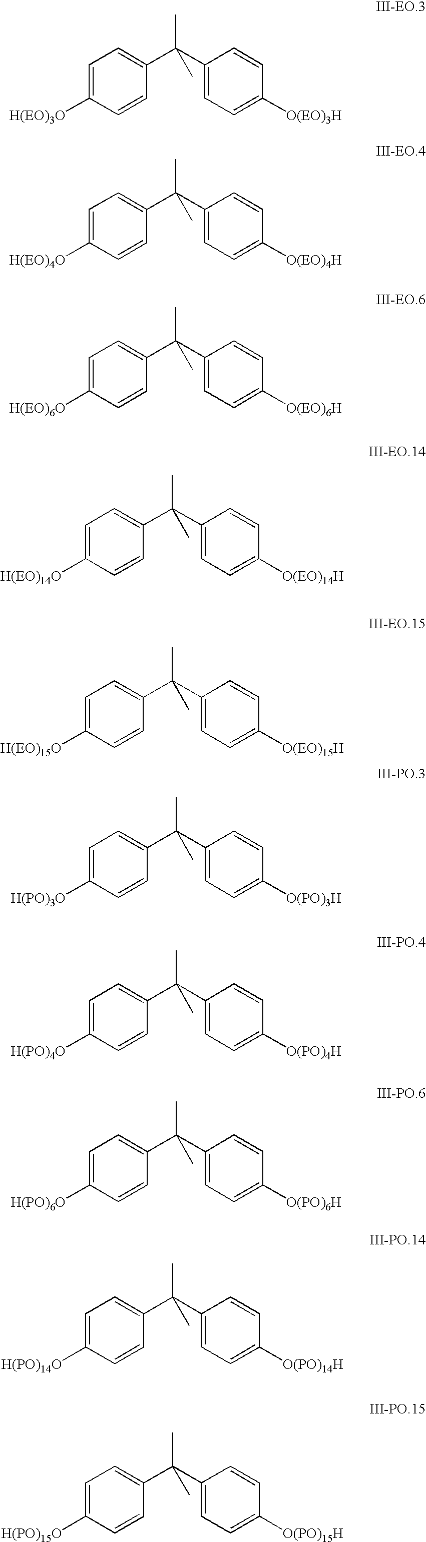

Examples of suitable triols (D) are glycerol, 1,1,1-trimethylolethane, 1,1,1-trimethylol-propane, 1,1,1-trimethylolbutane, 1,2,4-butanetriol and 1,2,3-butanetriol.

Examples of suitable polyols (D) are aliphatic compounds having 4 or more hydroxyl groups per molecule, for example diglycerol, sorbitol, mannitol, pentaerythritol, dimeric pentaerythritol, glucose, fructose and mannitol.

In one embodiment of the present invention, aqueous formulation used in the process of the present invention comprises reaction product (B), carbodiimide (C) and diol (D) or triol (D) or polyol (D) side by side.

To react carbodiimide (C) with diol (D), trio (D) or polyol (D), carbodiimide (C) may be mixed with diol (D), triol (D) or polyol (D) and preferably heated together, for example to temperatures in the range from 50 to 120° C., preferably 60 to 100° C.

To react carbodiimide (C) with diol (D), triol (D) or polyol (D), it is preferable to select such carbodiimides as have one or more and preferably two or more terminal groups capable of reacting with hydroxyl groups. Examples of particularly suitable terminal groups are carboxyl groups and isocyanate groups.

The reaction of carbodiimide (C) with diol (D), triol (D) or polyol (D) can be carried out with or without catalyst.

Reaction product (B) may be isolated and purified. For example, unconverted diol (D), trio (D) or polyol (D), as the case may be, may be separated off. However, in a preferred embodiment of the present invention, reaction product (B) is not isolated and purified and is used with any impurities.

Carbodiimide (C) and diol (D) or trio (D) or polyol (D) may be used in stoichiometric amounts. For instance, when carbodiimide (C) has two isocyanate groups per molecule, it can be reacted with two moles of diol (D) or trio (D) or polyol (D).

In another embodiment, carbodiimide (C) and diol (D) or triol (D) or polyol (D) are reacted with each other in a nonstoichiometric ratio with or without subsequent purification.

Reaction product (B) generally comprises at least one carbodiimide group per molecule.

In one embodiment of the present invention, aqueous formulation used for carrying out the process of the present invention comprises at least one carbodiimide (C). Carbodiimides (C) are described above.

In one embodiment of the present invention, aqueous formulation used for carrying out the process of the present invention comprises at least one diol (D), triol (D) or polyol (D). Diols (D), triols (D) and polyols (D) are described above.

One embodiment of the present invention comprises using at least one reaction product (B), either in lieu of carbodiimide (C) and in lieu of diol, triol or polyol (D), or reaction product (B) is used in addition to carbodiimide (C) or in addition to diol, triol or polyol (D), or reaction product (B) is used in addition to carbodiimide (C) and diol, triol or polyol (D).

In one embodiment of the present invention, aqueous formulation used in the process of the present invention comprises carbodiimide (C) and if appropriate diol (D) or triol (D) or polyol (D) side by side.

One embodiment of the present invention comprises using at least one reaction product (B) obtainable by reaction of at least one isocyanato-containing carbodiimide (C) with diethylene glycol, triethylene glycol, tetraethylene glycol or polyethylene glycol.

One embodiment of the present invention comprises using at least one reaction product (B) obtainable by reaction of a polymeric carbodiimide obtainable by polycondensation of m-TMXDI or p-TMXDI or mixtures of m-TMXDI and p-TMXDI having 2 to 20, preferably up to 15 and more preferably up to 10-N═C═N— groups per mole, with polyethylene glycol.

In one embodiment of the present invention, aqueous formulation further comprises at least one pigment (E).

Pigments (E) are herein to be understood as virtually insoluble, dispersed, finely divided, organic or inorganic colorants in accordance with the definition in German standard specification DIN 55944. Preference is given to selecting at least organic pigment and/or metal pigment.

Illustratively selected organic pigments are

monoazo pigments: C.I. Pigment Brown 25; C.I. Pigment Orange 5, 13, 36 and 67; C.I. Pigment Red 1, 2, 3, 5, 8, 9, 12, 17, 22, 23, 31, 48:1, 48:2, 48:3, 48:4, 49, 49:1, 52:1, 52:2, 53, 53:1, 53:3, 57:1, 63, 112, 146, 170, 184, 210, 245 and 251; C.I. Pigment Yellow 1, 3, 73, 74, 65, 97, 151 and 183;
disazo pigments: C.I. Pigment Orange 16, 34 and 44; C.I. Pigment Red 144, 166, 214 and 242; C.I. Pigment Yellow 12, 13, 14, 16, 17, 81, 83, 106, 113, 126, 127, 155, 174, 176 and 188;
anthanthrone pigments: C.I. Pigment Red 168 (C.I. Vat Orange 3);
anthraquinone pigments: C.I. Pigment Yellow 147 and 177; C.I. Pigment Violet 31;
anthraquinone pigments: C.I. Pigment Yellow 147 and 177; C.I. Pigment Violet 31;
anthrapyrimidine pigments: C.I. Pigment Yellow 108 (C.I. Vat Yellow 20);
quinacridone pigments: C.I. Pigment Red 122, 202 and 206; C.I. Pigment Violet 19;
quinophthalone pigments: C.I. Pigment Yellow 138;
dioxazine pigments: C.I. Pigment Violet 23 and 37;
flavanthrone pigments: C.I. Pigment Yellow 24 (C.I. Vat Yellow 1);
indanthrone pigments: C.I. Pigment Blue 60 (C.I. Vat Blue 4) and 64 (C.I. Vat Blue 6);
isoindoline pigments: C.I. Pigment Orange 69; C.I. Pigment Red 260; C.I. Pigment Yellow 139 and 185;
isoindolinone pigments: C.I. Pigment Orange 61; C.I. Pigment Red 257 and 260; C.I. Pigment Yellow 109, 110, 173 and 185;
isoviolanthrone pigments: C.I. Pigment Violet 31 (C.I. Vat Violet 1);
metal complex pigments: C.I. Pigment Yellow 117, 150 and 153; C.I. Pigment Green 8;
perinone pigments: C.I. Pigment Orange 43 (C.I. Vat Orange 7); C.I. Pigment Red 194 (C.I. Vat Red 15);
perylene pigments: C.I. Pigment Black 31 and 32; C.I. Pigment Red 123, 149, 178, 179 (C.I. Vat Red 23), 190 (C.I. Vat Red 29) and 224; C.I. Pigment Violet 29;
phthalocyanine pigments: C.I. Pigment Blue 15, 15:1, 15:2, 15:3, 15:4, 15:6 and 16; C.I. Pigment Green 7 and 36;
pyranthrone pigments: C.I. Pigment Orange 51; C.I. Pigment Red 216 (C.I. Vat Orange 4);
thioindigo pigments: C.I. Pigment Red 88 and 181 (C.I. Vat Red 1); C.I. Pigment Violet 38 (C.I. Vat Violet 3);
triarylcarbonium pigments: C.I. Pigment Blue 1, 61 and 62; C.I. Pigment Green 1; C.I. Pigment Red 81, 81:1 and 169; C.I. Pigment Violet 1, 2, 3 and 27; C.I. Pigment Black 1 (aniline black);
C.I. Pigment Yellow 101 (aldazine yellow);

### C.I. Pigment Brown 22.

Examples of particularly preferred pigments are: C.I. Pigment Yellow 138, C.I. Pigment Red 122 and 146, C.I. Pigment Violet 19, C.I. Pigment Blue 15:1, 15:2, 15:3 and 15:4, C.I. Pigment Black 7, C.I. Pigment Orange 5, 38 and 43 and C.I. Pigment Green 7.

Useful pigments (E) further include metallic pigments such as for example gold bronze, silver bronze, glitter. Also useful are pigments (E) having different colors depending on the viewing angle, examples being color-variable pigments: Paliochrome, Variochrome and also liquid crystal special-effect pigments based on crosslinked, including highly crosslinked, cholesteric LC phases.

The average diameter of pigment (E) is typically in the range from 20 nm to 1.5 μm and preferably in the range from 300 to 500 nm.

In the event that pigment (E) is selected from the group of effect pigments, it is preferable to select platelet-shaped effect pigments, for example having an average diameter in the range from 100 nm to 1.5 μm and a thickness in the range from 20 nm to 200 nm, the average diameter preferably being at least twice the thickness.

The aqueous formulation used for carrying out the process of the present invention may further comprise one or more active components (F), in addition to or in lieu of pigment (E). Suitable active components (F) may be selected for example from flame retardants, scents, insect-destroying agents (insecticides) and plasticizers. Examples of particularly preferred plasticizers are ester compounds selected from the groups of the aliphatic or aromatic di- or polycarboxylic acids fully esterified with alkanols or the phosphoric acid at least singly esterified with alkanol.

In one embodiment of the present invention, alkanols comprise C₄-C₁₈-alkanols and preferably C₆-C₁₄-alkanols, branched or preferably unbranched.

Preferred examples of fully alkanol-esterified aromatic di- or polycarboxylic acids are fully alkanol-esterified phthalic acid, isophthalic acid and mellitic acid; suitable examples are: di-n-octyl phthalate, di-n-nonyl phthalate, di-n-decyl phthalate, di-n-octyl isophthalate, di-n-nonyl isophthalate, di-n-decyl isophthalate.

Preferred examples of fully C₄-C₁₈-alkanol-esterified aliphatic di- or polycarboxylic acids are for example di-n-butyl adipate, diisobutyl adipate, di-n-butyl glutarate, diisobutyl glutarate, di-n-butyl succinate, diisobutyl succinate and also mixtures thereof.

Preferred examples of at least singly alkanol-esterified phosphoric acid are C₄-C₁₈-alkyl di-C₆-C₁₄-aryl phosphates such as isodecyl diphenyl phosphate.

Further suitable examples of plasticizers are aliphatic or aromatic di- or polyols at least singly esterified with C₁-C₁₀-alkylcarboxylic acid at least singly.

Preferred examples of aliphatic or aromatic di- or polyols at least singly esterified with C₁-C₁₀-alkylcarboxylic acid is 2,2,4-trimethylpentane-1,3-diol monoisobutyrate.

Further suitable plasticizers are polyesters obtainable by polycondensation of aliphatic dicarboxylic acid and aliphatic or cycloaliphatic diol, for example adipic acid or succinic acid or 1,2-cyclohexanediol or 1,2- or 1,4-cyclohexanedimethanol (as isomeric mixture or as one of the pure isomers) and 1,2-propanediol, preferably having an M, in the range from 200 to 2000 g/mol, and polypropylene glycol alkylphenyl ether, preferably having an M_{w} in the range from 450 to 5000 g/mol.

Further suitable plasticizers are polypropylene glycols etherified with two different alcohols and having a molecular weight M_{w} in the range from 400 to 800 g/mol, wherein preferably one of the alcohols may be an alkanol, in particular a C₄-C₁₈-alkanol and the other alcohol may preferably be an aromatic alcohol, for example o-cresol, m-cresol, p-cresol and particularly phenol.

To conduct a waterproof coating or a blackout coating, black or white solid particles such as for example kaolin, carbon black or titanium dioxide may also be used as active component (F).

In one embodiment of the present invention, aqueous formulation may comprise one or more auxiliary components (G). Auxiliary components (G) may be selected for example from thickeners, solvents, wetting agents, defoamers, hand improvers, dispersants, water-retaining agents, antisettling agents and/or biocides. Examples of suitable auxiliary components (G) are mentioned hereinbelow.

In one embodiment of the present invention, aqueous formulations used in the process of the present invention optionally comprise one or more microcapsule materials (H), herein also referred to as microcapsules.

The microcapsules included according to the present invention are particles having a capsular core consisting predominantly, to more than 95% by weight, of latent heat storage material and a polymer as capsular wall. The capsular core is solid or liquid depending on the temperature. The average particle size of the capsules (Z-average by light scattering) is in the range from 0.5 to 100 μm, preferably in the range from 1 to 80 μm and in particular in the range from 1 to 50 μm. The weight ratio of capsular core to capsular wall is generally in the range from 50:50 to 95:5. A core/wall ratio in the range from 70:30 to 93:7 is preferred.

Latent heat storage materials are by definition substances having a phase transition in the temperature range in which heat transfer is to take place. Preferably, latent heat storage materials have a solid/liquid phase transition in the temperature range from 0 to 70° C., in particular in the range from 10 to 50° C., more preferably in the range from 18 to 35° C., depending on the desired application. The latent heat storage material is generally an organic, preferably lipophilic, substance.

Examples of Suitable Substances are:
aliphatic hydrocarbon compounds such as saturated or unsaturated C₁₅-C₄₀-hydrocarbons, which are branched or preferably linear, e.g., n-pentadecane (melting point of 10° C.), n-hexadecane, n-heptadecane, n-octadecane, n-nonadecane, n-eicosane, n-heneicosane, n-docosane, n-tricosane, n-tetracosane, n-pentacosane, n-hexacosane, n-heptacosane, n-octacosane, more preferably n-hexadecane with a melting point of 18° C., n-octadecane with a melting point of 28° C., n-eicosane with a melting point of 35° C.
aromatic hydrocarbyl compounds
saturated or unsaturated C₆-C₄₀-fatty acids, such as lauric, stearic, oleic or behenic acid, preferably eutectic mixtures of decanoic acid with e.g. myristic, palmitic or lauric acid;
fatty alcohols and the so-called oxo alcohols which are obtained by hydroformylation of α-olefins and further reactions;
C₆-C₄₀-fatty amines, such as decylamine, dodecylamine, tetradecylamine or hexadecylamine;
esters such as C₁-C₁₀-alkyl esters of fatty acids, such as propyl palmitate, methyl stearate or methyl palmitate, and preferably their eutectic mixtures or methyl cinnamate;
natural and synthetic waxes, such as montan acid waxes, montan ester waxes, carnauba wax, polyethylene wax, oxidized waxes, polyvinyl ether wax, ethylene vinyl acetate wax or hard waxes in accordance with Fischer-Tropsch processes;
halogenated hydrocarbons.

Mixtures of these substances are also suitable provided the melting point is not lowered outside of the desired range, or the heat of fusion of the mixture is too low for a useful application.

useful application.

For example, the use of pure n-alkanes, n-alkanes with a purity greater than 80% or of alkane mixtures as are produced as technical-grade distillate and as such are commercially available is advantageous.

In addition, it may be advantageous to add to capsule core-forming substances compounds which are soluble therein in order to prevent the lowering of the freezing point which sometimes arises with nonpolar substances. As described in U.S. Pat. No. 5,456,852 it is advantageous to use compounds with a melting point at from 20 to 120 K higher than the actual core substance. Suitable compounds are the fatty acids, fatty alcohols, fatty amides and aliphatic hydrocarbon compounds mentioned above as lipophilic substances. They are added in amounts of from 0.1% to 10% by weight, based on the capsule core.

The latent heat storage material is chosen according to the temperature range in which the heat storage effect is desired.

As polymer for the capsule wall it is possible in principle to use the formaldehyde-free materials known for the microcapsules for carbonless copy papers. It is for instance possible to encapsulate the latent heat storage materials by the processes described in GB-A 870476, U.S. Pat. No. 2,800,457, U.S. Pat. No. 3,041,289 in gelatin with other polymers.

Preferred wall materials, since they are very resistant to aging, are thermoset polymers. Thermoset herein refers to wall materials which, owing to a high degree of crosslinking, do not soften, but decompose at high temperatures. Suitable thermoset wall materials are for example highly crosslinked polyurethanes and also highly crosslinked methacrylic ester polymers.

The resins are used as prepolymers in the processes known from carbonless copy papers. The prepolymer is still soluble in the aqueous phase and migrates in the course of the polycondensation to the interface and encloses the oil droplets. Processes for microencapsulation with formaldehyde resins are common knowledge and described for example in EP-A 0 562 344 and EP-A 0 974 394.

Capsule walls composed of polyurethanes are likewise known from carbonless copy papers. The capsule walls are formed by reaction of NH₂— or OH-bearing reactants with di- and/or polyisocyanates. Suitable isocyanates are for example ethylene diisocyanate, 1,4-tetramethylene diisocyanate, 1,6-hexamethylene diisocyanate, 2,4-tolylene diisocyanate and 2,6-tolylene diisocyanate. Polyisocyanates such as derivatives of biuret structure, polyuretoneimines and isocyanurates may further be mentioned. Useful reactants include: hydrazine, guanidine and its salts, hydroxylamine, and di- and polyamines and amino alcohols. Interfacial polyaddition processes of this kind are known for example from U.S. Pat. No. 4,021,595 and EP-A 0 392 876 and EP-A 0 535 384.

Preference is given to microcapsules whose capsule wall is a highly crosslinked methacrylic ester polymer. The degree of crosslinking is achieved with a crosslinker content of not less than 10% by weight based on the entire polymer.

In preferred microcapsules, the wall-forming polymers are constructed from 10% to 100% by weight and preferably from 30% to 95% by weight of one or more C₁-C₂₄-alkyl esters of acrylic and/or methacrylic acid as monomers 1. The polymers may further comprise up to 80% by weight, preferably from 5% to 60% by weight and in particular from 10% to 50% by weight of a substantially water-insoluble bi- or polyfunctional monomer as monomers II in interpolymerized form. The polymers may additionally comprise up to 90% by weight, preferably up to 50% by weight, in particular up to 30% by weight of other monomers III in interpolymerized form.

Suitable monomers I are C₁-C₂₄-alkyl esters of acrylic and/or methacrylic acid. Particularly preferred monomers I are methyl, ethyl, n-propyl and n-butyl acrylate and/or the corresponding methacrylates. Preference is given to isopropyl, isobutyl, sec-butyl and tert-butyl acrylate and the corresponding methacrylates. Methacrylonitrile should also be mentioned. In general, the methacrylates are preferred.

Suitable monomers II are bi- or polyfunctional monomers which are insoluble or sparingly soluble in water, but have a good to limited solubility in the lipophilic substance. Sparingly soluble is understood as meaning a solubility of less than 60 g/l at 20° C. Bi- or polyfunctional monomers are understood as meaning compounds which have at least 2 nonconjugated ethylenic double bonds. Of particular suitability are divinyl and polyvinyl monomers which bring about crosslinking of the capsule wall during the polymerization.

Preferred bifunctional monomers are the diesters of diols with acrylic acid or methacrylic acid, and also the diallyl and divinyl ethers of these diols.

Preferred divinyl monomers are ethanediol diacrylate, divinylbenzene, ethylene glycol dimethacrylate, 1,3-butylene glycol dimethacrylate, methallylmethacrylamide and allyl methacrylate. Particular preference is given to propanediol diacrylate, butanediol diacrylate, pentanediol diacrylate and hexanediol diacrylate or the corresponding methacrylates.

Preferred polyvinyl monomers are trimethylolpropane triacrylate and methacrylate, pentaerythritol triallyl ether and pentaerythritol tetraacrylate.

Suitable monomers III are other monomers, preference being given to monomers IIIa such as vinyl acetate, vinyl propionate and vinylpyridine.

Particular preference is given to the water-soluble monomers IIIb, e.g., acrylonitrile, methacrylamide, acrylic acid, methacrylic acid, itaconic acid, maleic acid, maleic anhydride, N-vinylpyrrolidone, 2-hydroxyethyl acrylate and methacrylate and acrylamido-2-methylpropanesulfonic acid. In addition, N-methylolacrylamide, N-methylolmethacrylamide, dimethylaminoethyl methacrylate and diethylaminoethyl methacrylate in particular should be mentioned.

In a further preferred embodiment, the wall-forming polymers are formed of from 30% to 90% by weight of methacrylic acid, 10% to 70% by weight of an alkyl ester of (meth)acrylic acid, preferably methyl methacrylate, tert-butyl methacrylate, phenyl methacrylate and cyclohexyl methacrylate, and 0% to 40% by weight of further ethylenically unsaturated monomers. These further ethylenically unsaturated monomers may be the monomers 1, II or III hitherto not mentioned for this embodiment. Since they generally have no significant effect on the formed microcapsules of this embodiment, their fraction is preferably <20% by weight, in particular <10% by weight. Such microcapsules and their preparation are described in EP-A 1 251 954, incorporated by reference.

The microcapsules suitable for the use according to the invention can be prepared by a so-called in-situ polymerization.

Preferred microcapsules and their preparation are known from EP-A 0 457 154, DE-A 101 39 171, DE-A 102 30 581 and EP-A 1 321 182, to which reference is expressly made. Thus, the microcapsules are produced by using the monomers, a free-radical initiator, a protective colloid and the lipophilic substance to be encapsulated to produce a stable oil-in-water emulsion in which they are present as dispersed phase. Polymerization of the monomers is then triggered by heating and controlled through a further temperature increase, the resulting polymers forming the capsule wall which encloses the lipophilic substance.

The temperature at which the polymerization is carried out is generally in the range from 20 to 100° C. and preferably in the range from 40 to 80° C. Of course, the dispersion and polymerization temperature should be above the melting temperature of the lipophilic substances.

After the end temperature has been reached, the polymerization is conveniently continued for about a period of up to 2 hours in order to reduce residual monomer contents. After the actual polymerization reaction at a conversion of 90% to 99% by weight, it is generally advantageous to render the aqueous microcapsule dispersions largely free of odor carriers, such as residual monomers and other organic volatile constituents. This can be achieved in a manner known per se by physical means by distillative removal (in particular by means of steam distillation) or by stripping with an inert gas. It may also be carried out by chemical means, as described in WO 99/24525, advantageously by redox-initiated polymerization, as described in DE-A 44 35 423, DE-A 44 19 518 and DE-A 44 35 422.

In this way it is possible to produce microcapsules having an average particle size in the range from 0.5 to 100 μm, it being possible to adjust the particle size in a manner known per se via the shear force, the stirring speed, the protective colloid and its concentration.

Preferred protective colloids are water-soluble polymers since these reduce the surface tension of the water from 73 mN/m maximum to 45 to 70 mN/m and thus ensure the formation of sealed capsule walls, and form microcapsules having preferred particle sizes in the range from 1 to 30 μm and preferably from 2 to 10 μm.

In general, microcapsules are produced in the presence of at least one organic protective colloid, which may be either anionic or neutral. Anionic and nonionic protective colloids may also be used together. Preference is given to using inorganic protective colloids if appropriate in the mixture with organic protective colloids or nonionic protective colloids.

Organic neutral protective colloids are cellulose derivatives, such as hydroxyethylcellulose, methylhydroxyethylcellulose, methylcellulose and carboxymethylcellulose, polyvinylpyrrolidone, copolymers of vinylpyrrolidone, gelatin, gum Arabic, xanthan, sodium alginate, casein, polyethylene glycols, preferably polyvinyl alcohol and partially hydrolyzed polyvinyl acetates and methylhydroxypropyl-cellulose.

Suitable anionic protective colloids are polymethacrylic acid, the copolymers of sulfoethyl acrylate and methacrylate, sulfopropyl acrylate and methacrylate, N-(sulfoethyl)maleimide, 2-acrylamido-2-alkylsulfonic acids, styrenesulfonic acid and vinylsulfonic acid.

Preferred anionic protective colloids are naphthalenesulfonic acid and naphthalenesulfonic acid-formaldehyde condensates and in particular polyacrylic acids and phenolsulfonic acid-formaldehyde condensates.

The anionic and nonionic protective colloids are generally used in amounts of from 0.1% to 10% by weight, based on the water phase of the emulsion.

Preference is given to inorganic protective colloids, so-called Pickering systems, which enable stabilization through very fine solid particles and are insoluble but dispersible in water or are insoluble and nondispersible in water, but wettable by the lipophilic substance.

Their mode of action and use is described in EP-A 1 029 018 and EP-A 1 321 182, both incorporated by reference.

A Pickering system can here consist of the solid particles on their own or additionally of auxiliaries which improve the dispersibility of the particles in water or the wettability of the particles by the lipophilic phase.

The inorganic solid particles may be metal salts, such as salts, oxides and hydroxides of calcium, magnesium, iron, zinc, nickel, titanium, aluminum, silicon, barium and manganese. Examples are magnesium hydroxide, magnesium carbonate, magnesium oxide, calcium oxalate, calcium carbonate, barium carbonate, barium sulfate, titanium dioxide, aluminum oxide, aluminum hydroxide and zinc sulfide. Silicates, bentonite, hydroxyapatite and hydrotalcites may likewise be mentioned. Particular preference is given to finely divided silicas, magnesium pyrophosphate and tricalcium phosphate.

The Pickering systems may be added either firstly to the water phase, or be added to the stirred emulsion of oil-in-water. Some fine solid particles are prepared by a precipitation as described in EP-A-1 029 018, and EP-A-1 321 182.

The finely divided silicas may be dispersed as fine solid particles in water. It is, however, also possible to use so-called colloidal dispersions of silica in water. The colloidal dispersions are alkaline, aqueous mixtures of silica. In the alkaline pH range, the particles are swollen and are stable in water. For a use of these dispersions as Pickering system, it is advantageous if the pH of the oil-in-water emulsion is adjusted to pH 2 to 7 with an acid.

The inorganic protective colloids are generally used in amounts of from 0.5% to 15% by weight, based on the water phase.

In general, the organic neutral protective colloids are used in amounts of from 0.1% to 15% by weight, preferably from 0.5% to 10% by weight, based on the water phase.

Preferably, the dispersion conditions for preparing the stable oil-in-water emulsion are chosen in a manner known per se such that the oil droplets have the size of the desired microcapsules.

The as-polymerized microcapsule dispersions are spray dried to give a free-flowing capsular powder. The microcapsule dispersion may be spray dried in a conventional manner. The general procedure adopted is such that the inlet temperature of the hot air stream is in the range from 100 to 200° C. and preferably in the range from 120 to 160° C. and the outlet temperature of the hot air stream is in the range from 30 to 90° C. and preferably in the range from 60 to 80° C. The aqueous polymeric dispersion can be sprayed in the stream of hot air, for example, by using single-material or multimaterial nozzles or via a rotating disk. The polymeric powder is normally precipitated by means of cyclones or filter separators. The spray-dispensed aqueous polymeric dispersion and the stream of hot air are preferably routed in parallel.

If appropriate, spraying assistants are added at the spray-drying stage to facilitate the spray-drying operation or achieve certain powder properties, for example low dust, flowability or improved redispersibility. A multiplicity of spraying assistants will be familiar to those skilled in the art. Examples of spraying assistants are to be found in DE-A 19629525, DE-A 19629526, DE-A 2214410, DE-A 2445813, EP-A 407889 or EP-A 784449. Advantageous spraying assistants are for example water-soluble polymers of the polyvinyl alcohol type or partially hydrolyzed polyvinyl acetates, cellulose derivatives, such as hydroxyethylcellulose, carboxymethylcellulose, methylcellulose, methylhydroxyethylcellulose and methylhydroxypropylcellulose, polyvinylpyrrolidone, copolymers of vinylpyrrolidone, gelatin, preferably polyvinyl alcohol and partially hydrolyzed polyvinyl acetates and methylhydroxypropylcellulose.

The process of the present invention can be carried out in common apparatus or machinery. For instance, substrates can be saturated with aqueous formulation. It is further possible to apply aqueous formulation by spraying, blade coating or by means of air-knife coating.

When textile substrates (textiles) are to be treated, pad-mangles are preferred. The essential element of suitable pad-mangles is two squeeze rollers through which the textile is led. The aqueous formulation is introduced above the rollers and wets the textile. The pressure causes the textile to be squeezed off and ensures a constant add-on level.

In a further embodiment, the textile is led over a deflecting roller through a trough with the aqueous formulation. Excess aqueous formulation is subsequently squeezed off through a pair of rolls which is mounted above the aqueous formulation, thereby ensuring a constant add-on level.

In one embodiment of the present invention, the treating of substrate with aqueous formulation may be followed by a thermal treatment, in one or more treating steps. It is possible for example to dry thermally and/or fix thermally, preference being given to drying at temperatures in the range from 70 to 120° C. for a period in the range from 30 seconds to 30 minutes and/or fixing, if appropriate following the drying operation, at temperatures in the range from 140° C. to 200° C. for a period in the range from 30 seconds to 15 minutes.

The process of the present invention provides coated, preferably printed substrates, preferably flexible substrates and more preferably textile substrates having altogether advantageous properties, in particular a low tendency to gray, and which do not emit formaldehyde. Substrates obtainable by the process of the present invention likewise form part of the subject matter of the present invention and are also referred to as substrates of the present invention. Substrates of the present invention comprise reaction products of carbodiimide (C) with the diol (D), triol (D) or polyol (D) used.

The present invention further provides aqueous formulations comprising
(A) at least one binder comprising ethylene, (meth)acrylic acid and if appropriate one or more further comonomers in interpolymerized form,
(B) at least one reaction product of at least one carbodiimide (C) with at least one diol, triol or polyol (D), or
(C) at least one carbodiimide,
(D) optionally at least one diol, triol or polyol,
(E) optionally at least one pigment,
(F) optionally at least one active component,
(G) optionally at least one auxiliary component,
(H) optionally at least one microcapsule material.

Aqueous formulations in accordance with the present invention may comprise for example dyeing liquors, coating liquors or finishing liquors and preferably comprise print pastes.

Binders (A), reaction products (B), carbodiimides (C), diols (D), triols (D), polyols (D) and pigments (E) are described above.

To use such aqueous formulations in accordance with the present invention as comprise one or more pigments (E), it is preferable to use pigment (E) in the form of a pigment preparation. Pigment preparations for the purposes of the present invention can be produced by intensively mixing one or more pigments (E) with one or more dispersing auxiliaries. Useful dispersing auxiliaries include for example surfactants, particularly nonionic surfactants such as for example multiply ethoxylated C₁₀-C₃₀ fatty alcohols or multiply ethoxylated C₁₁-C₃₁ oxo process alcohols.

Auxiliary components (G) include for example thickeners (thickening agents), solvents, defoamers, wetting agents, hand improvers, dispersants, emulsifiers, water-retaining agents, antisettling agents and/or biocides. Thickeners and defoamers are preferred auxiliary components.

Aqueous formulations in accordance with the present invention may comprise for example one or more natural thickeners or preferably one or more synthetic thickeners. Natural thickeners are such thickeners as are natural products or as are obtainable by workup such as for example purifying operations, in particular extraction of natural products. Examples of inorganic natural thickeners are sheet silicates such as bentonite for example. Examples of organic natural thickeners are preferably proteins such as for example casein or preferably polysaccharides. Particularly preferred natural thickeners are selected from agar, carrageenan, gum arabic, alginates such as for example sodium alginate, potassium alginate, ammonium alginate, calcium alginate and propylene glycol alginate, pectins, polyoses, carob bean gum (Carubin) and dextrins.

Preference is given to using synthetic thickeners selected from generally liquid solutions of synthetic polymers, particularly acrylates, in for example white oil or as aqueous solutions. Synthetic polymers used as thickeners comprise acid groups, which are neutralized with ammonia completely or to a certain percentage. In the course of the fixing operation, ammonia is released, reducing the pH and starting the actual fixing. The pH reduction necessary for fixing may alternatively be effected by adding nonvolatile acids such as for example citric acid, succinic acid, glutaric acid or malic acid. Similarly, diammonium phosphate and sodium diammonium phosphate are useful for lowering the pH.

Very particularly preferred synthetic thickeners are selected from copolymers of 85% to 95% by weight of acrylic acid, 4% to 14% by weight of acrylamide and 0.01% to not more than 1% by weight of the (meth)acrylamide derivative of the formula IV

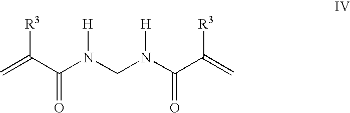

or 0.01% to not more than 1% by weight of bis(meth)acrylate of ethylene glycol or propylene glycol
having molecular weights M_{w} in the range from 100 000 to 2 000 000 g/mol, in each of which the R³ radicals may be the same or different and may each represent methyl or hydrogen.

Aqueous formulations of the present invention may comprise one or more solvents, which in the context of the present invention is to be understood as referring to organic solvents such as for example methanol, ethanol or isopropanol.

Aqueous formulations of the present invention may comprise one or more defoamers. Suitable defoamers are for example siliconic defoamers such as for example those of the formula HO—(CH₂)₃—Si(CH₃)[OSi(CH₃)₃]₂ and HO—(CH₂)₃—Si(CH₃)[OSi(CH₃)₃][OSi(CH₃)₂OSi(CH₃)₃], nonalkoxylated or alkoxylated with up to 20 equivalents of alkylene oxide and particularly ethylene oxide. Silicone-free defoamers are also suitable, examples being multiply alkoxylated alcohols, for example fatty alcohol alkoxylates, preferably 2 to 50-tuply ethoxylated preferably unbranched C₁₀-C₂₀-alkanols, unbranched C₁₀-C₂₀-alkanols and 2-ethylhexan-1-ol. Further suitable defoamers are fatty acid C₈-C₂₀-alkyl esters, preferably C₁₀-C₂₀-alkyl stearates, in each of which C₈-C₂₀-alkyl and preferably C₁₀-C₂₀-alkyl may be branched or unbranched. Further suitable defoamers are trialkyl phosphates such as triisobutyl phosphate for example.

Aqueous formulations of the present invention may comprise for example one or more wetting agents, preferably low-sudsing wetting agents, since sudsing can impair the quality of the treatment through formation of unlevelnesses. Wetting agents used include for example: ethoxylation and/or propoxylation products of fatty alcohols or propylene oxide-ethylene oxide block copolymers, ethoxylated or propoxylated fatty or oxo process alcohols, also ethoxylates of oleic acid or alkylphenols, alkylphenol ether sulfates, alkylpolyglycosides, alkyl phosphonates, alkylphenyl phosphonates, alkyl phosphates or alkylphenyl phosphates.

Aqueous formulations of the present invention may further comprise one or more hand improvers, typically selected from silicones, in particular polydimethylsiloxanes, and fatty acid esters.

Aqueous formulations of the present invention may comprise one or more dispersants. Examples of suitable dispersants are aryl- or alkyl-substituted polyglycol ethers, also substances described in U.S. Pat. No. 4,218,218 and homologs where y (from the formulae of U.S. Pat. No. 4,218,218) is in the range from 10 to 37.

Aqueous formulations of the present invention may comprise one or more emulsifiers. Suitable emulsifiers may be cationic, anionic or preferably nonionic. Examples of nonionic emulsifiers are for example singly or multiply alkoxylated, preferably propoxylated and particularly multiply, for example 3 to 100-tuply, ethoxylated fatty alcohols, oxo process alcohols and particularly aryl polyglycol ethers, for example of the formula V a to V c:

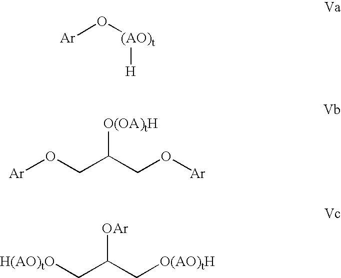

where
Ar: in each occurrence is different or if appropriate the same, C₆-C₁₄-aryl, for example phenyl, naphthyl or phenanthryl, unsubstituted or singly or multiply substituted, in particular with C₁-C₄-alkyl, branched or unbranched, for example methyl, ethyl, n-propyl, isopropyl, n-butyl, isobutyl, or with alkylaryl, for example styryl; preferred substituted phenyl radicals are each substituted with C₁-C₄-alkyl in the 2,6-position or in the 2,4,6-position.
t in each occurrence is different or preferably the same and selected from numbers in the range from 1 to 100, preferably in the range from 2 to 50 and more preferably in the range from 3 to 20.

Aqueous formulations of the present invention may comprise one or more water-retaining agents. Urea is an example of a suitable water-retaining agent.

Aqueous formulations of the present invention may comprise one or more biocides. Suitable biocides are for example commercially available as Proxel brands. Examples which may be mentioned are: 1,2-benzisothiazolin-3-one (“BIT”) (commercially available as Proxel® brands from Avecia Lim.) and its alkali metal salts; other suitable biocides are 2-methyl-2H-isothiazole-3-one (“MIT”) and 5-chloro-2-methyl-2H-isothiazol-3-one (“CIT”).

Examples of suitable antisettling agents are silicates and silica gels, for example with an average particle diameter (in particular secondary particle diameter) in the range from 10 to 500 nm, particularly pyrogenic silica gels. Suitable pyrogenic silica gels are commercially available as Aerosil® brands for example.

Aqueous formulations of the present invention may comprise one or more foaming agents as auxiliary component (G), in particular if they are to be used for coating, examples of foaming agents being ammonium salts of fatty acids, preferably ammonium stearate.

It is possible for one auxiliary component (G) to perform more than one function. For example, multiply ethoxylated fatty alcohols such as for example n-C₁₈H₃₇O(CH₂CH₂O)₁₅H can simultaneously act as a wetting agent, as an emulsifier and as a low-sudsing dispersant.

In one embodiment of the present invention, aqueous formulations of the present invention comprise 1% to 15% by weight % by weight, preferably 1.5% to 10% by weight and more preferably 2% to 5% by weight of binder (A). This embodiment is preferred when aqueous formulation of the present invention is to be embodied for a process for printing substrates.

In another embodiment of the present invention, aqueous formulations of the present invention comprise 10% to 25% by weight, preferably 12% to 20% by weight of binder (A). This embodiment is preferred when aqueous formulation of the present invention is to be embodied for a process for coating substrates.

In another embodiment of the present invention, aqueous formulations of the present invention comprise 0.5% to 15% by weight, preferably up to 5% by weight of binder (A). This embodiment is preferred when aqueous formulation of the present invention is to be embodied for a process for dyeing substrates.

In one embodiment of the present invention, aqueous formulations of the present invention further comprise

0.1% to 15% by weight and preferably 0.1% to 6% by weight of reaction product (B) or
0.1% to 15% by weight and preferably 0.2% to 6% by weight of carbodiimide (C),
zero to 3% by weight and preferably 0.1% to 2.5% by weight of diol (D), triol (D) or polyol (D),
zero to 10% by weight and preferably 0.05% to 3% by weight of pigment (E),
zero to in total up to 10% by weight and preferably up to 6% by weight of auxiliary component or components (G).
Weight % ages are each based on total aqueous formulation of the present invention.
Quantities specified for binder (A) or other constituents of aqueous formulation of the present invention are each based on the solids content of binder (A), etc.

Aqueous formulations of the present invention further comprise water.

In one embodiment of the present invention, aqueous formulations of the present invention have a water content in the range from 60% to 95% by weight and preferably in the range from 80% to 95% by weight. This embodiment is preferred when aqueous formulation of the present invention is to be exerted as a print paste for a process for dyeing substrates.

In one embodiment of the present invention, aqueous formulations of the present invention have a water content in the range from 20% to 80% by weight and preferably in the range from 30% to 70% by weight. This embodiment is preferred when aqueous formulation of the present invention is to be exerted for a process for coating substrates.

In one embodiment of the present invention, aqueous formulations of the present invention have a water content in the range from 90% to 98% by weight. This embodiment is preferred when aqueous formulation of the present invention is to be exerted as a liquor for a process for dyeing substrates.

In one embodiment of the present invention, the dynamic viscosity of aqueous formulation of the present invention at 23° C. is in the range from 10 to 100 dPa·s and preferably in the range from 20 to 30 dPa·s, determined for example by rotary viscometry, for example using a Haake viscometer. The aforementioned viscosity range applies particularly when aqueous formulation of the present invention is a print paste.

In another embodiment of the present invention, aqueous formulation of the present invention comprises a dyeing liquor.

Dyeing liquors of the present invention comprise at least one binder (A), at least one reaction product (B) or at least one carbodiimide (C), preferably at least one diol (D), triol (D) or polyol (D), preferably at least one pigment (E) and if appropriate one or more auxiliary components (G). Auxiliary component or components (G) can be selected from the aforementioned auxiliary components (G). Preferably, however, dyeing liquor of the present invention comprises no thickener.

Dry textile wovens, yarns, filaments, formed-loop knits or batts as used in continuous pigment dye containing a large amount of air. The pigment dyeing process of the present invention is therefore advantageously practiced using deaerators. These are based for example on polyether siloxane copolymers. They can be included in dyeing liquor of the present invention in amounts from 0.01 to 2 g/l.

Dyeing liquors of the present invention may further comprise antimigration agents. Suitable antimigration agents are for example block copolymers of ethylene oxide and propylene oxide having molecular weights Mₙ in the range from 500 to 5000 g/mol and preferably in the range from 800 to 2000 g/mol.

The dyeing liquors of the present invention may further include one or more hand improvers as an ingredient. Hand improvers are preferably polysiloxanes or waxes. Polysiloxanes have the advantage in this context of being durable, whereas waxes are gradually washed off during use.

Dyeing liquors of the present invention typically have a weakly acidic pH, preferably in the range from 4 to 6.5, or a weakly alkaline pH, for example in the range from 7.1 to 9.5, set for example with ammonia. The surface tensions of dyeing liquors of the present invention are to be adjusted such that wetting of the fabric is possible. Surface tensions of less than 50 mN/m at 23° C. are suitable for example.

In one embodiment of the present invention, a dyeing liquor of the present invention comprises per liter

0 to 100 g and preferably 0.1 to 10 g of wetting agent,
0 to 100 g and preferably 0.1 to 10 g of defoamer,
0 to 100 g and preferably 1 to 50 g of antimigration agent,
0.5 to 25 g and preferably 1 to 12 g of pigment (E)
as well as binder (A), reaction product (B) or carbodiimide (C) and if appropriate diol (D), triol (D) or polyol (D).

In one embodiment of the present invention, the dynamic viscosity of aqueous formulation of the present invention at 23° C. is in the range below 100 mPa·s, measured at 20° C. The aforementioned viscosity limit applies particularly when aqueous formulation of the present invention is a dyeing liquor.

Aqueous formulations of the present invention are particularly suitable for carrying out the process of the present invention. They also exhibit particularly good stability in storage and stability to shearing.

The present invention further provides a process for producing aqueous formulations of the present invention. The present invention's process for producing formulations of the present invention is accomplished by mixing together and particularly by stirring together
(A) at least one binder comprising ethylene, (meth)acrylic acid and if appropriate one or more further comonomers in interpolymerized form,
(B) at least one reaction product of at least one carbodiimide (C) with at least one diol, triol or polyol (D), or
(C) at least one carbodiimide and
(D) optionally at least one diol, trio or polyol,
(E) optionally at least one pigment,
(F) optionally at least one active component,
(G) optionally at least one auxiliary component,
(H) optionally at least one microcapsule material,
   and if appropriate filling up with water.

The order of addition of constituents (A) to (H) is freely choosable. When one or more thickeners are to be used as auxiliary component (G), it is preferable to add the thickener or thickeners last or directly before making up with water.

The present invention's process for producing formulations of the present invention can be carried out in any desired vessels. To use one or more thickeners as auxiliary component (G), it is preferable to mix using a high speed stirrer, for example an Ultra-Thurrax.

This invention is elucidated by working examples.

### Preliminary Remark:

The level of free (detached) formaldehyde was in each case determined according to Law 112 and according to AATCC 112 methods (EN ISO 14 184 Parts 1 and 2), DIN EN ISO 14184-1 and DIN EN ISO 14184-2.

### I. Production of Inventive Aqueous Formulations (Print Pastes)

The following ingredients were used:

Binder (A.1): Aqueous dispersion (20% by weight solids content) of a random copolymer of 20% by weight of acrylic acid, 80% by weight of ethylene, M_{w}: 20 000 g/mol, neutralized with N,N-dimethylethanolamine, pH 9.

Reaction Products (B.1-1) and (B.1-2)

Reaction products (B) were prepared under protective gas atmosphere (predried nitrogen).

The procedure adopted to prepare reaction product (B.1-1) was as follows:

A carbodiimide (C.1) based on meta-TMXDI and having a titrimetrically determined NCO content of 6.7% by weight (corresponding to about 4.2 carbodiimide groups/molecule) was dried at 60° C. in a thermal cabinet for 24 hours in an amount of 500 g. The carbodiimide (C.1) thus dried was introduced as initial charge into a 2 l four neck flask equipped with drying tube, stirrer, thermometer and gas inlet tube, heated to 60° C. and admixed with 500 g of polyol (D.2) (polyethylene glycol having an average molecular weight Mₙ of 600 g/mol) by stirring. This was followed by heating to 90° C. The reaction mixture thus obtainable was milky white at the beginning and then turned transparent. It was cooled down to 80° C. and stirred at 80° C. for 90 minutes. This was followed by cooling to obtain reaction product (B.1-1), which was liquid at room temperature, water-soluble and no longer contained any isocyanate groups.

To prepare reaction product (B.1-2), 450 g of carbodiimide (C.1) and 550 g of polyol (D.2) were reacted with each other similarly to the procedure described above to obtain reaction product (B.1-2) which was likewise liquid at room temperature, water-soluble and no longer contained any isocyanate groups.

To prepare reaction product (B.1-3), 550 g of carbodiimide (C.1) and 450 g of polyol (D.2) were reacted with each other similarly to the procedure described above to obtain reaction product (B.1-3) which was likewise liquid at room temperature, water-soluble and no longer contained any isocyanate groups.

### Carbodiimide (C):

(C.1): Carbodiimide based on m-TMXDI (having a titrimetrically determined NCO content of 6.7% by weight). This corresponds to about 4.2 carbodiimide groups/molecule.

### Diols (D):

(D.1) Dipropylene glycol

(D.2) Polyethylene glycol having an average molecular weight Mₙ of 600 g/mol

### Pigment (E.1): Pigment Formulation

The following were milled together in a Drais Superflow DCP SF 12 stirred media mill:

### 2640 g of Pigment Blue 15:3

460 g of n-C₁₈H₃₇O(CH₂CH₂O)₂₅H
600 g of glycerol
2300 g of distilled water
Milling was continued until the pigment particles had an average diameter of 100 nm. This gave pigment formulation P(E.1).

### Auxiliary Components:

(G.1) Copolymer of acrylic acid (92% by weight), acrylamide (7.6% by weight), methylenebisacrylamide V.1 (0.4% by weight), quantitatively neutralized with ammonia (25% by weight in water), molecular weight M_{w} of about 150 000 g/mol

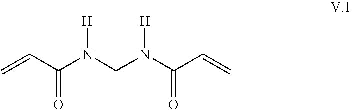

(G.2) C₁₃ OXO process alcohol, saturated

(G.3): Polydimethylsiloxane, dynamic viscosity 5000 mPa·s, determined at 23° C.

Print pastes were produced according to the following general prescription:

The ingredients of table 1 were stirred together in a stirred vessel in the following order: The initial charge was 200 ml of water, to which (G.3) was added. (C.1) and binder (A.1) were subsequently added with stirring. This was followed by addition with stirring of diol (D.1), (G.1), (E.4) and finally P(E.1). The mixture was made up with water to one liter and was subsequently stirred for 15 minutes using a high speed stirrer of the Ultra-Turrax type at about 6000 revolutions/min.

This gave inventive print pastes as per table 1 or the corresponding comparative print paste.

TABLE 1
Compositions of inventive print pastes DP.2, DP.3 and DP.5 to DP.8 and
of comparative print paste V-DP.1 and V-DP.4

| Ingredient | V-DP.1 | DP.2 | DP.3 | V-DP.4 | DP.5 | DP.6 | DP.7 | DP.8 | DP.9 | DP.10 |
|---|---|---|---|---|---|---|---|---|---|---|
| (A.1) | 12 | 12 | 12 | 12 | 12 | 12 | 12 | 12 | 12 | 12 |
| (B.1-1) | — | — | — | — | 4.5 | 4.5 | — | — | — | — |
| (B.1-2) | — | — | — | — | — | — | 4.5 | 4.5 | — | — |
| (B.1-3) | | | | | | | | | 4.5 | 4.5 |
| (C.1) | — | 4.5 | 4.5 | — | — | — | — | — | | |
| (D.1) | — | — | 15 | — | — | 15 | — | 15 | — | 15 |
| P(E.1) | 7 | 7 | 7 | 7 | 7 | 7 | 7 | 7 | 7 | 7 |
| (G.1) | 30 | 30 | 30 | 30 | 30 | 30 | 30 | 30 | 30 | 30 |
| (G.2) | 2 | 2 | 2 | 2 | 2 | 2 | 2 | 2 | 2 | 2 |
| (G.3) | 25 | 25 | 25 | 25 | 25 | 25 | 25 | 25 | 25 | 25 |

All amounts reported for ingredients are in g and are based on the respective solids, only the data for pigment formulation P(E.1) are gross.

### III. Printing Polypropylene Textiles

Substrates composed of woven polypropylene fabric, areal weight 170 g/m², were screen printed. The printing parameters were: squeegee 15 mm, ESTAL MONO E 55 screen gauze, magnetic pull level 6, simple print, no pattern.

The print was dried in a drying cabinet at 80° C. for 10 minutes and subsequently fixed on a fixing cabinet by heating with hot air at 110° C. for five minutes.

This gave comparative textile V-PP.1 and inventive polypropylene textiles PP.2 and PP.3.

The inventive substrates were tested for rubfastness, wet and dry, to DIN EN ISO 105-X12 and washfastness to DIN EN ISO 105-CO₃. Best possible result: a rating of 5, worst possible result: a rating of 1.

This gave the following inventive substrates and test results as per table 2:

TABLE 2
Substrates printed according to invention and test results

| Print paste No. | Substrate No. | Rubfastness dry | Rubfastness wet |
|---|---|---|---|
| V-DP.1 | V-PP.1 | 3 | 3 |
| DP.2 | PP.2 | 4-5 | 3-4 |
| DP.3 | PP.3 | 4-5 | 4-5 |
| V-DP.4 | V-PP.4 | 3 | 3 |
| DP.5 | PP.5 | 4-5 | 3-4 |
| DP.6 | PP.6 | 4-5 | 4-5 |
| DP.7 | PP.7 | 4-5 | 4 |
| DP.8 | PP.8 | 4-5 | 4-5 |
| DP.9 | PP.9 | 4-5 | 4-5 |
| DP.10 | PP.10 | 4-5 | 4-5 |

None of the substrates printed according to the present invention exhibited detectable emissions of formaldehyde.

1. A process for treating a substrate, which comprises utilizing at least one aqueous formulation comprising
(A) at least one binder obtainable by copolymerization of ethylene and (meth)acrylic acid and if appropriate one or more further comonomers,
(B) at least one reaction product of at least one polymeric carbodiimide (C) with at least one diol, triol or polyol (D), or
(C) at least one polymeric carbodiimide and
(D) optionally at least one diol, triol or polyol.

2. The process according to claim 1 wherein the substrate comprises a textile substrate.

3. The process according to claim 1 wherein the treating comprises printing, dyeing or coating.

4. The process according to claim 1 wherein the aqueous formulation comprises a print paste.

5. The process according to claim 1 wherein the aqueous formulation in question further comprises
(E) at least one pigment.

6. The process according to claim 1 wherein the treating with aqueous formulation is followed by thermal treating.

7. The process according to claim 1 wherein flexible substrates are chosen from sheetlike substrates composed of cotton, polyester and polyolefins.

8. The process according to claim 1 wherein binder (A) is selected from copolymers comprising (meth)acrylic acid, glycidyl(meth)acrylate or a C₂-C₁₀-hydroxyalkyl(meth)acrylate as interpolymerized comonomer.

9. The process according to claim 1 wherein polymeric carbodiimide (C) comprises a polymeric carbodiimide based on m-TMXDI or p-TMXDI.

10. The process according to claim 1 wherein at least one reaction product (B) of at least one polymeric carbodiimide (C) with at least one diol, triol or polyol (D) is obtainable by reaction of at least one isocyanato-containing carbodiimide with diethylene glycol, triethylene glycol, tetraethylene glycol or polyethylene glycol.

11. The process according to claim 1 wherein the aqueous formulation in question comprises
at least one microcapsule material (H).

12. The process according to claim 1 wherein said substrate comprises a textile substrate composed of polypropylene.

13. An aqueous formulation comprising
(A) at least one binder, obtainable by copolymerization of ethylene and (meth)acrylic acid and if appropriate one or more further comonomers,
(B) at least one reaction product of at least one polymeric carbodiimide (C) with at least one diol, triol or polyol (D), or
(C) at least one polymeric carbodiimide and
(D) optionally at least one diol, triol or polyol.

14. The aqueous formulation according to claim 13 comprising a print paste.

15. The aqueous formulation according to claim 13 further comprising
(E) at least one pigment.

16. The aqueous formulation according to claim 13 wherein binder (A) is selected from copolymers comprising (meth)acrylic acid, glycidyl(meth)acrylate or a C₂-C₁₀-hydroxyalkyl(meth)acrylate as interpolymerized comonomer.

17. The aqueous formulation according to claim 13 wherein polymeric carbodiimide (C) comprises a polymeric carbodiimide based on m-TMXDI or p-TMXDI.

18. The process for producing an aqueous formulation according to claim 13 by mixing together
(A) at least one binder, obtainable by copolymerization of ethylene and (meth)acrylic acid and if appropriate one or more further comonomers,
(B) at least one reaction product of at least one polymeric carbodiimide (C) with at least one diol, triol or polyol (D), or
(C) at least one polymeric carbodiimide and
(D) optionally at least one diol, triol or polyol,
(E) optionally at least one pigment,
(F) optionally at least one active component,
(G) optionally at least one auxiliary component,
(H) optionally at least one microcapsule material,
and if appropriate filling up with water.

19. A substrate printed by a process according to claim 1.
